(19) United States
(12) Patent Application Publication
(10) Pub. No.: US 2011/0181773 A1
(43) Pub. Date: Jul. 28, 2011

(54) IMAGE PROCESSING APPARATUS

(75) Inventors: Jun OHASHI, Ome-shi (JP); Kentaro Nagahama, Kodaira-shi (JP)

(73) Assignee: KABUSHIKI KAISHA TOSHIBA, TOKYO (JP)

(21) Appl. No.: 12/873,661

(22) Filed: Sep. 1, 2010

(30) Foreign Application Priority Data
Jan. 25, 2010 (JP) 2010-013571

(51) Int. Cl. H04N 7/088

(52) U.S. Cl. 348/465; 348/E07.035

(57) ABSTRACT

According to one embodiment receiving-unit is configured to receive a broadcast signal employing a first subtitle format capable of designating a display-position and executing a plurality of subtitle displays. The display-position-detecting-unit is configured to detect a display-position of a subtitle in accordance with subtitle information included in the broadcast signal received by the receiving-unit. The character-string-detecting-unit is configured to detect a character string of the subtitle in accordance with the subtitle information. The subtitle-generating-unit is configured to generate subtitle information in a second subtitle format in capable of executing a plurality of subtitle displays. The subtitle-generating-unit arranges white space characters as the subtitle from a start point of a display area of the subtitle, arranges the character string detected by the character-string-detecting-unit, and generates the subtitle information in the second subtitle format, to display the character string detected by the character-string-detecting-unit at the display-position detected by the display-position-detecting-unit.

### CROSS-REFERENCE TO RELATED APPLICATIONS

This application is based upon and claims the benefit of priority from Japanese Patent Application No. 2010-013571, filed Jan. 25, 2010; the entire contents of which are incorporated herein by reference.

### FIELD

Embodiments described herein relate generally to an image processing apparatus.

### BACKGROUND

If a resolution of a monitor displaying an image is different from a resolution of a received image, a subtitle is displayed by placing a leading part thereof at a position corresponding to the resolution of the monitor.

Recently, a subtitle format for an installation type stationary receiver of a large screen size and a subtitle format for a mobile receiver such as a cellular telephone of a small screen size, have been employed for digital broadcast. These formats are different in resolution, and have a gap in terms of the degree of freedom in layout and the decoration function.

On the other hand, a viewing form of transcoding the digital broadcast for stationary device and viewing it by a mobile device is generalized. This is implemented by converting a format of media of speech, image and subtitle into a format for a mobile device corresponding thereto, by PC, TV and a recorder.

As for subtitles, since the subtitle formats are different in terms at not only resolution, but also layout and decoration function as explained above, the formats cannot be appropriately converted by employing a publicly known technique.

In addition, a method of not converting the subtitle formats, but synthesizing the subtitles with images has been employed. However, since display or no display of subtitles can be set only at the time of converting the formats, subtitle display setting cannot be changed during reproduction at the terminal.

### BRIEF DESCRIPTION OF THE DRAWINGS

FIG. 1 is a block diagram showing a structure of an embodiment of at broadcast receiving apparatus comprising an image processing apparatus;

FIG. 2 is an illustration showing management of an area displaying subtitles in ISDB-T SUB;

FIG. 3 is an illustration showing subtitles in ISDB-T SUB;

FIG. 4 is an illustration showing subtitles in 3GPP Timed Text;

FIG. 5 is an illustration showing Timed Text generated by the broadcast receiving apparatus shown in FIG. 1;

FIG. 6 is an illustration showing a structure of a subtitle transcoder according to trio first embodiment of the broadcast receiving apparatus shown in FIG. 1;

FIG. 7 is a flowchart showing operations of the subtitle transcoder shown in FIG. 6;

FIG. 8 is an illustration showing operations oh the subtitle transcoder shown in FIG. 6;

FIG. 9 is an illustration showing operations of the subtitle transcoder shown in FIG. 6;

FIG. 10 is an illustration showing subtitles in DVD SUB;

FIG. 11 is an illustration showing a structure of a subtitle transcoder according to a second embodiment of the broadcast receiving apparatus shown in FIG. 1;

FIG. 12 is a flowchart showing operations of the subtitle transcoder shown in FIG. 11;

FIG. 13 is an illustration showing subtitles in DTVCC;

FIG. 14 is an illustration showing a structure of a subtitle transcoder according to a third embodiment of the broadcast receiving apparatus shown in FIG. 1;

FIG. 15 is a flowchart showing operations of the subtitle transcoder shown in FIG. 14;

FIG. 16 is an illustration showing Timed Text generated by the broadcast receiving apparatus shown in FIG. 15;

FIG. 17 is an illustration showing Timed Text generated by a modified example of the broadcast receiving apparatus shown in FIG. 1; and

FIG. 18 is a block diagram showing a structure of a modified example of the broadcast receiving apparatus shown in FIG. 1.

### DETAILED DESCRIPTION

Embodiments will be described below with reference to the accompanying drawings.

In general, according to one embodiment, an image processing apparatus includes a receiving unit, a display position detecting unit, character string detecting unit, and a subtitle generating unit. The receiving unit is configured to receive a broadcast signal employing a first subtitle format capable of designating a display position and executing a plurality of subtitle displays. The display position detecting unit is configured to detect a display position of a subtitle in accordance with subtitle information included in the broadcast signal received by the receiving unit. The character string detecting unit is configured to detect a character string of the subtitle in accordance with the subtitle information. The subtitle generating unit is configured to generate subtitle information in a second subtitle format in capable of executing a plurality of subtitle displays. The subtitle generating unit arranges a white space character as the subtitle from a start point of display area of the subtitle, arranges the character string detected by the character string detecting unit, and generates the subtitle information in the second subtitle format, to display the character string detected by the character string detecting unit at the display position detected by the display position detecting unit.

As digital broadcast standards, and subtitle formats capable of designating en arbitrary position on an image and displaying a plurality of subtitles different in character color and background color, for example, the following three digital broadcasts are assumed:

1. Digital broadcast constituted by applying a subtitle format defined under ARIB TR-B14 A Profile (hereinafter called ISDB-T SUB) to a digital television broadcast standard in Japan and South America, ISDB-T Integrated Services Digital Broadcasting—Terrestrial).
2. Digital broadcast constituted by applying a subtitle format defined under ETSI EN 300 743 (hereinafter called DVB SUB) to a digital television broadcast standard, DVB (Digital Broadcasting) mainly employed in Europe.

Digital broadcast constituted by applying a subtitle format defined under CEA 708 (hereinafter called DTVCC) to a digital television broadcast standard, ATSC (Advanced. Television Systems Committee) mainly employed in North America.

As the subtitle format for displaying subtitles on a predetermined position on an image, 3GPP Timed Text (hereinafter called Timed Text) standardized by 3GPP (3rd. Generation Partnership Project) and defined under 3GPP TS 26.234 is assumed.

In other words, the image processing apparatus according to this embodiment receives any one of the three digital broadcasts and displays subtitles in the Timed Text.

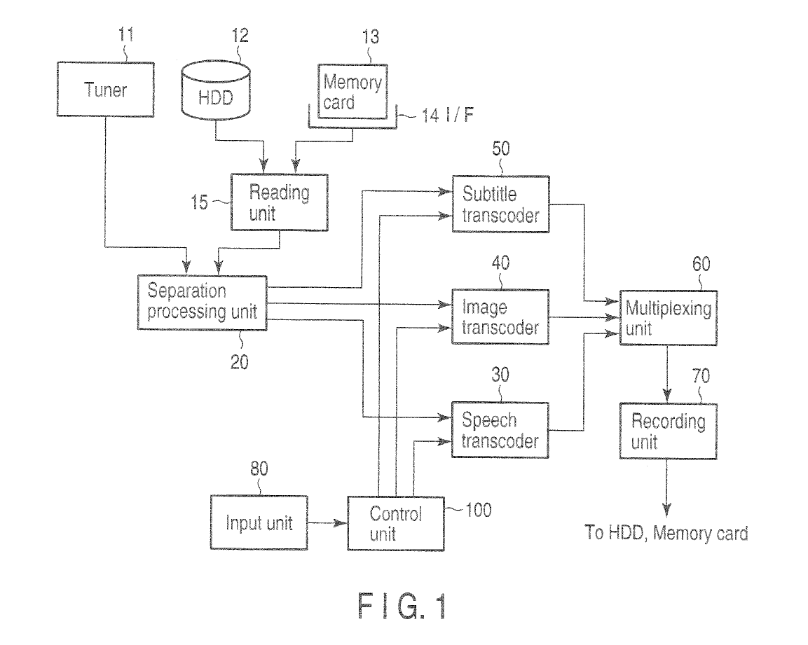

FIG. 1 shows a structure of a broadcast receiving apparatus comprising the image processing apparatus according to an embodiment of this embodiment. The broadcast receiving apparatus comprises a tuner 11, a hard disk drive (HDD) 12, a card interface (I/F) 14 for connection of a memory card 13, a reading unit 15, a separation processing unit 20, a speech transcoder 30, an image transcoder 40, a subtitle transcoder 50, a multiplexing unit 60, a recording unit 70, an input unit 80, and a control unit 100.

The tuner 11 receives, for example, satellite digital broadcast, ground digital broadcast, digital broadcast distributed via Internet, etc., demodulates the received signal and obtains multimedia data including media data such as speech, images, subtitles, etc.

The hard disk drive (HDD) 12 stores the multimedia data. In other words, the hard disk drive (HDD) 12 is a storage medium which does not reproduce the multimedia data obtained by the tuner 11, etc. at a real time, but is used to store the multimedia data to enable the user to view it when the user wishes to do so.

The memory card 13 is also a storage medium using a NAND type flash memory, etc. to store the multimedia data.

The card interface (I/F) 14 is an interface which has the memory card 13 electrically and physically connected thereto, and reads the data recorded in the memory card 13 or records the data in the memory card 13 under control of the reading unit 15.

The reading unit 15 controls the hard disk drive (HDD) 12 and reads the multimedia data recorded therein, controls the card interlace 11 and reads the multimedia data recorded in the memory card 13, and outputs the multimedia data to the separation processing unit 20.

The broadcast receiving apparatus also comprises a record processing unit which records the multimedia data obtained by the tuner 11 in the hard disk drive 12 and records the multimedia data in the memory card 13 through the card interface 14, though not shown in FIG. 1.

The separation processing unit 20 allows the multimedia data obtained by the tuner 11 and the multimedia data read by the reading unit 15 to be input therein, and separates the multimedia data to speech data, image data and subtitle data. The separated data are output to the speech transcoder 30, the image transcoder 40, and the subtitle transcoder 50 corresponding to the respective types of the data.

The speech transcoder 30 transcodes the speech data output from the separation processing unit 20 and converts the speech data into speech data which can be reproduced by the broadcast receiving apparatus, by a conversion parameter output from the control unit 100 to be described later.

The image transcoder 40 transcodes the image data output from the separation processing unit 20 and converts the mage data into image data which can be reproduced by the broadcast receiving apparatus, by a conversion parameter output from the control unit 100 to be described later.

The subtitle transcoder 50 executes conversion processing of the subtitle data output from the separation processing unit 20, by a conversion parameter output from the control unit 100, and obtains the subtitle data in Timed Text.

The multiplexing unit 60 multiplexes the speech data output from the speech transcoder 30, the image data output from the image transcoder 40, and the subtitle data output from the subtitle transcoder 50, into multimedia data. The data for the receiver such as a cellular telephone comprising a monitor of small size is thus obtained.

The recording unit 70 records the multiplexed multimedia data obtained by the multiplexing unit CO, in the hard disk drive 12 or memory card 13.

The multimedia data thus obtained are decoded to a speech signal, an image signal and a subtitle signal by a decoder (not shown). The signals may be output from a speaker (not shown) and an image may be displayed on a monitor (not shown). Subtitles based on the subtitle signal are superimposed on the image based on the image signal.

The input unit 80 is an interface which accepts a request from the user. For example, information such as the degree of speech quality, the degree of image quality, output resolution, a subtitle displaying method, etc. is arbitrarily input to the input unit 80.

The control unit 100 integrates and controls oil the units of the broadcast receiving apparatus. The control unit 100 generates the conversion parameters on the basis of the information input through the input unit 80, outputs a parameter concerning the speech to the speech transcoder 30, outputs a parameter concerning the image to the image transcoder 40, and outputs a parameter concerning the subtitles to the subtitle transcoder 50.

Next, detailed structure of the subtitle transcoder 50 according to this embodiment will be described. Since the subtitle formats to be employed are different under the digital television broadcast standards and the processing of the subtitle transcoder 50 is different according to the subtitle formats as explained above, the structure of the subtitle transcoder 50 will be described for each subtitle format. The structure in a case where the subtitle data are ISDB-T SUB will be described in a first embodiment, the structure in a case where the subtitle data are DVB SUB will be described in a second embodiment, and the structure in a case where the subtitle data are DTVCC will be described in a third embodiment.

### First Embodiment

### Subtitle Data in ISDB-T Sub

Subtitle data ISDB-T SUB is a PES (Packet Elementary Stream) packet format. The subtitle data are multiplexed in MPEG-2 TS format as the multimedia data together with the image data and speech data, and reproduced synchronously with the image and speech by PTS (Presentation Time Stamp) present in a PES header. In addition, the ISDB-T SUB includes subtitle sentence data which are information on subtitle sentences, and subtitle management data in which the control information is stored.

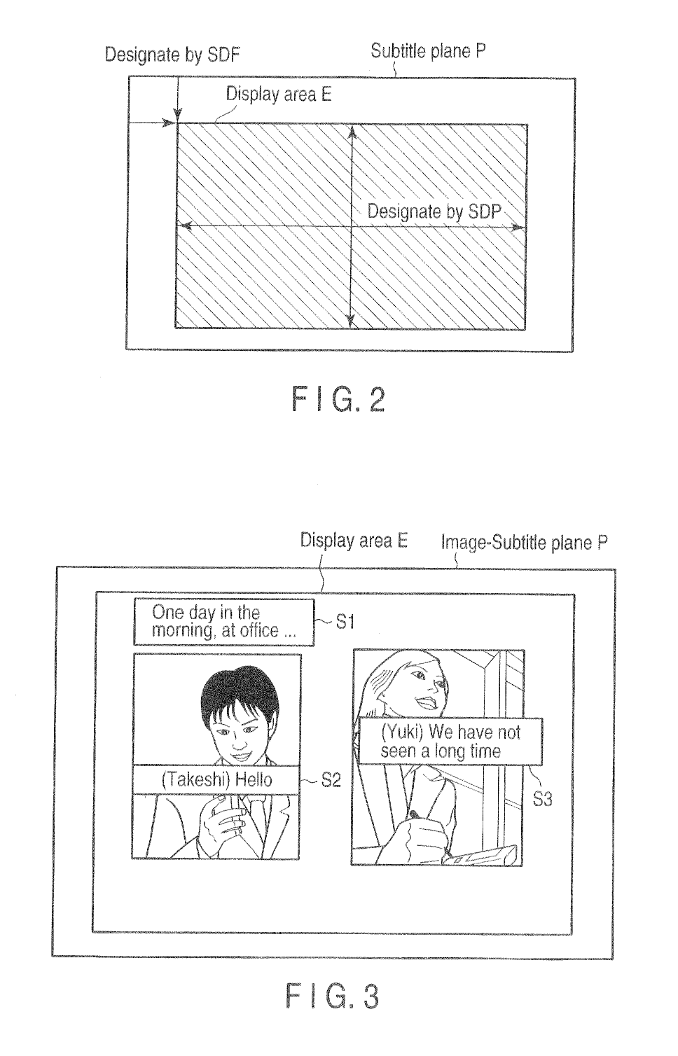

In the ground digital broadcast employing the ISDB-T SUB, the image and subtitles are managed in a logical area called plane P as shown in FIG. 2. In a general ground digital broadcast receiving apparatus, subtitles are overlaid on the image at the reproduction. In the broadcast receiving apparatus, the ISDB-T SUB is converted into Timed. Text to execute displaying. This conversion will be described later.

The general ground digital broadcast receiving apparatus will be described more specifically. In the general ground digital broadcast receiving apparatus, an arbitrary location starting at an origin coordinate of subtitle plane P is designated by control code SDP in the subtitle data and the size of a display area is designated by SDF. In addition, a background color is designated by COL. Display area 0 is thus set by control codes (SDP, SDF, COL) in the subtitle data. As shown in, for example, FIG. 3, subtitle sentences S1 to S3 are displayed in display area F, by location, character size, character interval, character color and background color designated by corresponding control codes, in unit of character.

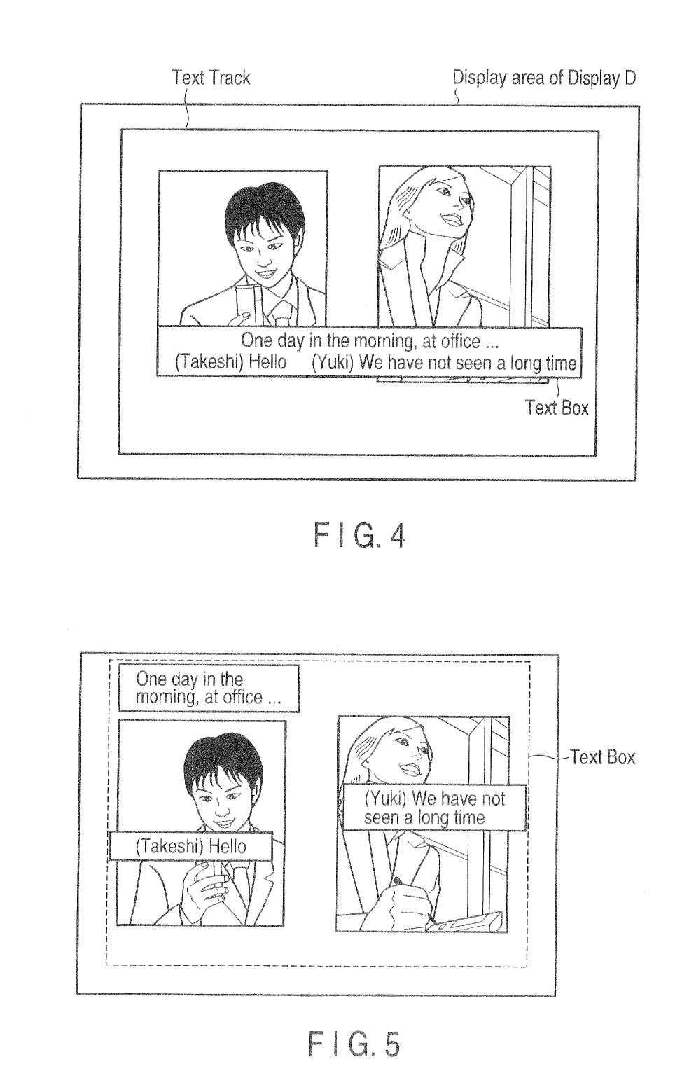

On the other hand, in the Timed Text, a display area Text Box whose background color can be designated can be set at an arbitrary location in logical area Text Track, of display area D on the display, as shown in FIG. 4, and a subtitle sentence having a character color designated in a unit of character can be displayed in the Text Box. However, since the Timed Text does not have a function of designating the display position in a unit of character or a function of designating the background color unlike the ISDB-T SUB, the ISDB-T SUB cannot be simply converted into the Timed Text.

For this reason, in the broadcast receiving apparatus according to this embodiment, the ISDB-T SUB is converted into the Timed Text by the subtitle transcoder 50 shown in FIG. 1. In other words, the subtitle transcoder 50 generates the Text Box corresponding to, for example, rectangular areas including respective subtitle sentences S1 to S3 shown in FIG. 3 and sets a background color of the Text Box to be transparent, as shown in FIG. 5. The subtitle transcoder 50 sets a white space character and a line feed from an upper left part of the screen, on the Text Box, and sets the subtitle sentences S1 to S3 at display positions designated in the ISDB-T SUB. Then, the subtitle transcoder 50 employs the highlight function as a decorating function which can be employed in the Timed Text and executes highlight display of each of the characters in the color designated as the background color of the ISDB-T SUB. Displaying is executed in this method, similarly to the displaying in the ISDB-T SUB.

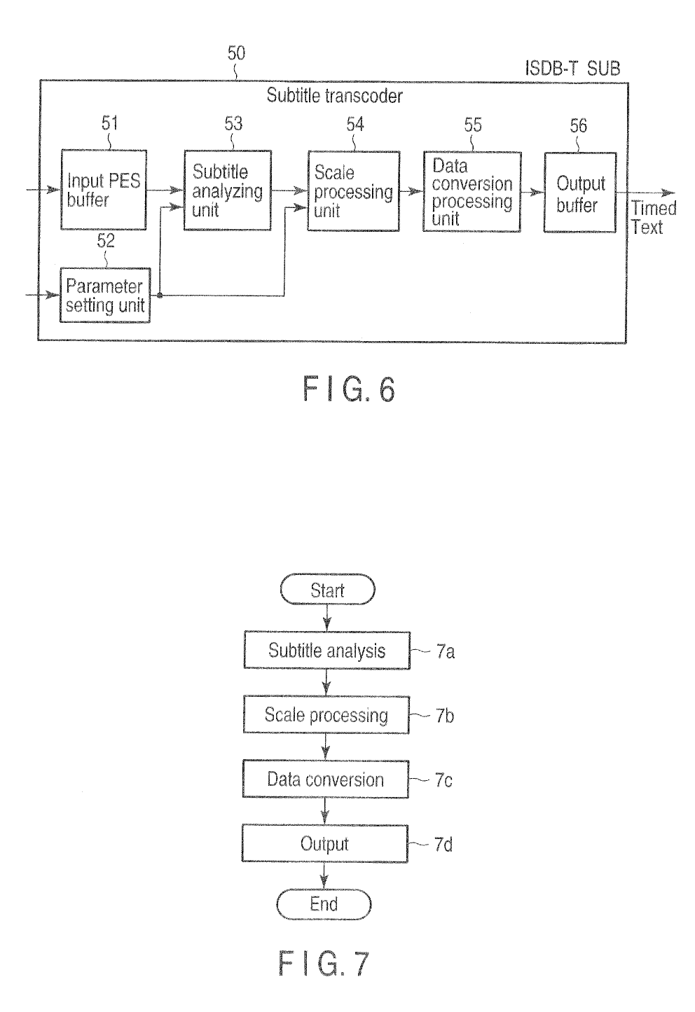

FIG. 6 shows a structure of the subtitle transcoder 50. The subtitle transcoder 50 comprises an input PES buffer 51, a parameter setting unit 52, a subtitle analyzing unit 53, a scale processing unit 54, a data conversion processing unit 55, and an output buffer 56. In this structure, processing shown in FIG. 7 is repeated.

The input PES buffer 51 temporarily stores the subtitle data supplied from the separation processing unit 20. In accordance with progress of the processing at a subsequent stage, PES packet of the subtitle data to be processed is read by the subtitle analyzing unit 53.

The parameter setting unit 52 notifies the scale processing unit 54 of an output resolution in which the ISDB-T SUB is converted into the Timed Text, on the basis of the conversion parameter supplied from the control unit 100.

The subtitle analyzing unit 53 analyzes the subtitle sentence data and the subtitle management data in step 7a. The subtitle analyzing unit 53 analyzes a character code and a control code in the subtitle sentence data, and detects a character string which is sequential in a horizontal direction (or a vertical direction at vertical writing) and which has the same background color, as a subtitle group. In addition, the subtitle analyzing unit 53 detects characters, character size, character color, background color, various decoration information included in each detected subtitle group, and detects start coordinates and end coordinates of each subtitle group. The subtitle analyzing unit 53 also analyzes the subtitle management data and changes a display format, etc. from the control code. In the example of FIG. 3, the subtitle group corresponds to S1 to S3.

The scale processing unit 54 executes scale conversion of converting the scales such as the character size and the start and end coordinates of each group analyzed by the subtitle analyzing unit 53, on the basis of a resolution of the subtitle plane P of the ISDB-T SUB (input resolution; for example, 960×540 or 720×480, etc.) and an output resolution (Text Track size) notified by the parameter setting unit 52, in step 7b.

For example, if the input resolution is 960×540 and the output resolution is 320×180, the character size and each of the coordinates are converted into one third. In addition, the character may not be reduced, but converted into a character of a greater size in consideration of the readability of the subtitles on a small monitor.

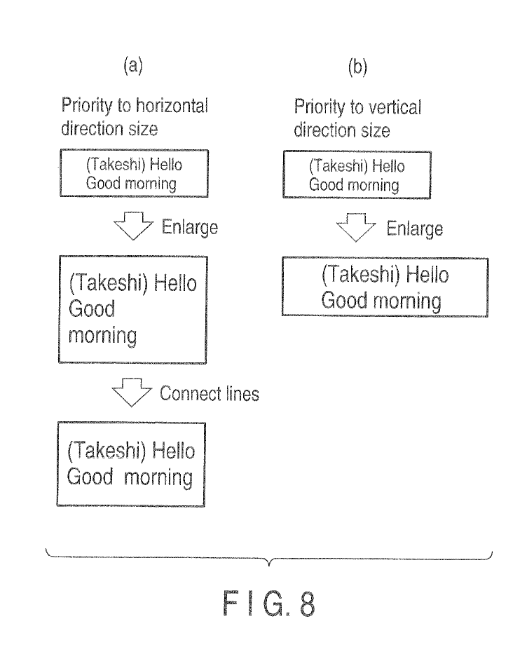

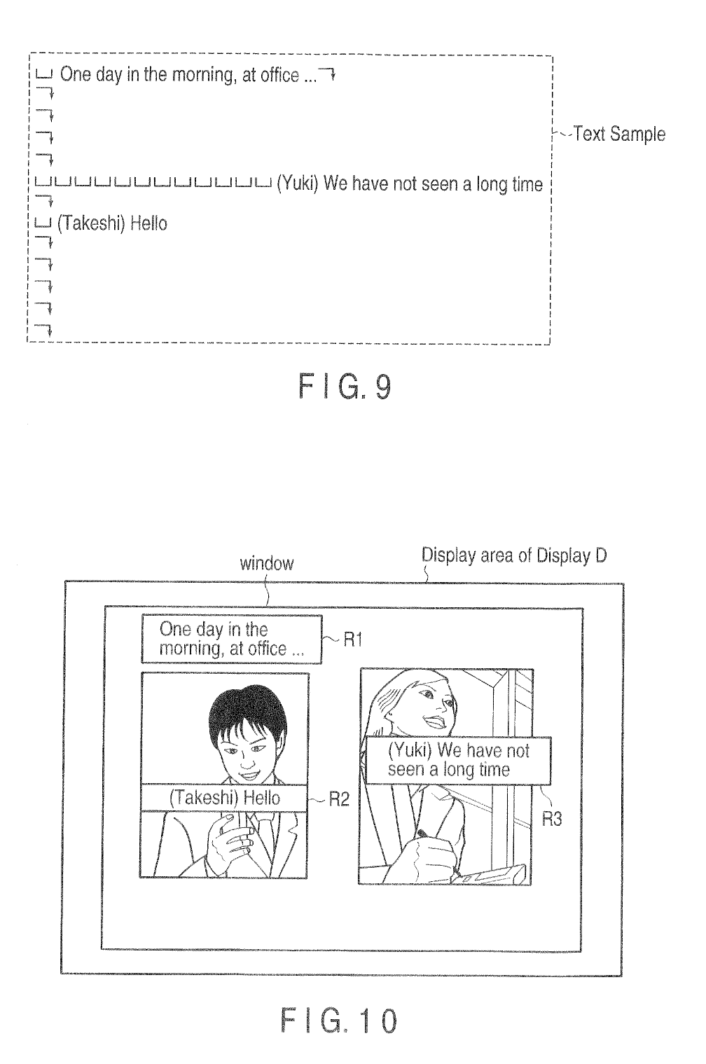

For example, if priority is given to setting the display size in a horizontal direction not to be greater than that in a vertical direction, at horizontal writing, a wrapping position and a line feed position of each line may be adjusted and the size of the group may be changed as shown in FIG. 8(a). Furthermore, a space from the line feed position to the wrapping position may be removed by connecting a plurality of lines. If priority is given to setting the display size in the vertical direction not to be greater than that in the horizontal direction, at the horizontal writing, the character size is expanded without changing the wrapping position and the line feed position of each line as shown in FIG. 8(b).

If the character string length of the subtitle sentence subjected to scale conversion exceeds the end coordinates over display area F, adjustment processing of enabling each subtitle group to be displayed at a desired position inside the display area E is executed by additionally executing the processing of changing the line feed and fonts and the processing of making the character size smaller.

The data conversion processing unit 55 first executes processing of converting 8-unit code into UTF-8 (or UTF-16) of Unicode, as the character code of the subtitle sentence in each subtitle group, in step 7c. Then, the data conversion processing unit 55 sets the Text Box of the size including all the subtitle groups (subtitle groups S1 to S3 in the example of FIG. 3). The size of the Text Box may be the same as the size of the Text Track.

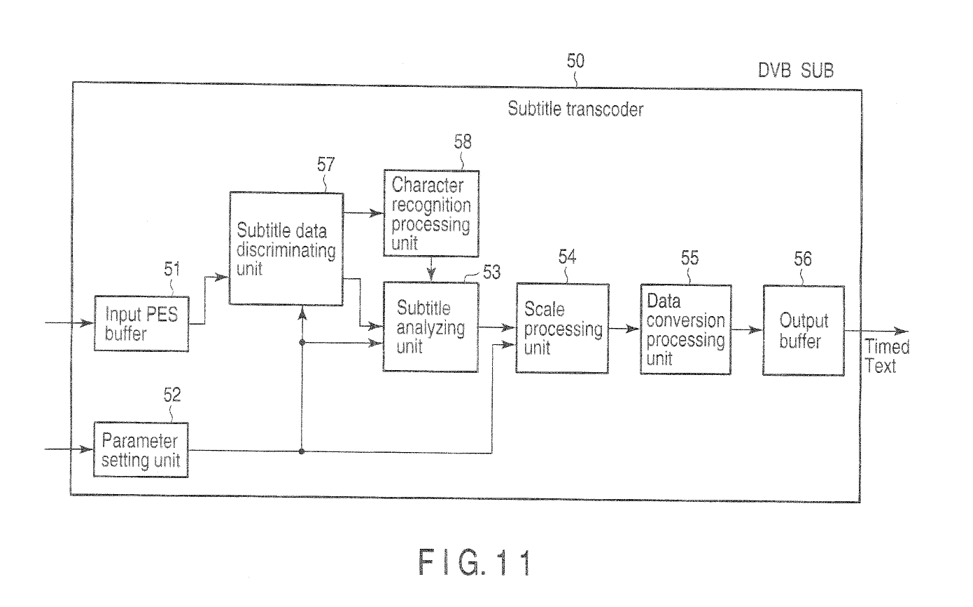

Furthermore, the data conversion processing unit 55 executes processing of arranging each subtitle group inside the Text Box. In other words, the data conversion processing unit 55 refers to the start coordinates of each subtitle group which are detected by the subtitle analyzing unit 53 and which are subjected to scale conversion by the scale processing unit 54, sets the white space character and the line iced code besides the subtitle sentence of each subtitle group such that the start coordinates are the start position of the corresponding subtitle group, adjusts the positional relationship of the image and subtitle to relatively correspond to the positional relationship of ISDB-T SUB, and Generates a Text Sample. In the example of FIG. 3, the data conversion processing unit 55 generates a Text Sample having Text Box shown in FIG. 10 as data, such that the positional relationship of each subtitle group is represented by the arrangement shown in FIG. 5. In FIG. 10, the subtitle sentences and adjustment of the positions thereof are represented by the settings of the white space character and the line feed code, and the setting of the background color is omitted.

In addition, the data conversion processing unit 55 executes decoration processing for the Text Sample. To execute decoration based on the decoration information (character color, scroll, blink) in the ISDB-T SUB detected by the subtitle analyzing unit 53, for the corresponding character in the Text Sample, the data conversion processing unit 55 implements the decoration processing by applying Text Style Box, Text Scroll Delay Box, etc. to the Text Sample. As for the background color of each subtitle group, the data conversion processing unit 55 implements the decoration processing by applying highlight processing using Text Highlight Box and Text Highlight Color Box to the Text Sample.

The data conversion processing unit 55 generates information on the output timing of the Text Sample, on the basis of the PTS of the PES packet. At an initial data conversion, the data conversion processing unit 55 generates Track Header Box as a header of Text Track, and Text Sample Entry in which a default parameter of Sample is set, in accordance with the Text Sample.

The output buffer 56 temporally stores the Text Sample generated by the data conversion of the data conversion processing unit 55 and the output timing information of the Text Sample and, at the initial data, the Text Sample Entry and the Track Header Box, in association with each other, and outputs them in accordance with the progress of the processing of the multiplexing unit 60 at the subsequent stage (or the process of the speech transcoder 30 and the image transcoder 40), in step 7d.

In the image processing apparatus having the above-described structure, when the ISDB-T SUB is converted into the Timed Text, the character string which is sequential in the horizontal direction (vertical direction at the vertical writing) and which has the same background color is detected as a subtitle group, the start coordinates of each subtitle group are detected, the position of each subtitle group is adjusted by setting the white space character and line feed code in the Text Box, and a Text Sample including a plurality of subtitle groups is thereby generated.

Therefore, since the ISDB-T SUB can converted into the Timed Text without substantially changing the relative display position, the display position of the subtitles can be dynamically changed similarly to the ISDB-T SUB, at the receiver capable of reproducing the digital broadcast in the Timed Text format.

### Second Embodiment

### Subtitle Data in DVB SUB

Subtitle data DVB SUB is a PES (Packet Elementary Stream) packet format. The subtitle data are multiplexed in MPEG-2 TS format as the multimedia data together with the image data and speech data, and reproduced synchronously with the image and speech by PTS (Presentation Time Stamp) present in a PES header.

The DVB SUB has information on the display size in the PES packet, sets a window as shown in FIG. 10 at an arbitrary position in the screen, in an arbitrary size, and displays the subtitles in a unit of display called “page” on the window. An area for displaying the subtitles (R1 to R3 in FIG. 10) is called “region”. A plurality of regions can beset at arbitrary positions on the window, in an arbitrary size.

The information on the display and the data for setting the “page” and “region” are stored in a payload of the PES packet as subtitle segments and can be distinguished by segment type parameters of the subtitle segments. The display information is stored in a display definition segment. The page information is stored in a page composition segment. The region information is stored in a region composition segment. The subtitle data are stored in an object data segment. The DVB SUB can employ the text format and the bit map format as the subtitle data, and the format can be distinguished by object_id parameter of the region composition segment. If the subtitle data are in the text format, the character code is stored in the object data segment. The character color and the background color are designated in the region composition segment. If the subtitle data are in the bit map format, the color information of each pixel is designated.

On the other hand, in the Timed. Text, a display area Text Box whose background color can be designated can be set at an arbitrary location in logical area Text Track, of display area D on the display, as shown in FIG. 4, and a subtitle sentence haying a character color designated in a unit of character can be displayed in the Text Box. However, since the Timed Text does not have a function of designating the display position in a unit of character and a function of designating the background color, unlike the DBV SUB, or a function of displaying the data in the bit map format as the subtitles, the DVB SUB cannot be simply converted into the Timed Text.

For this reason, in the broadcast receiving apparatus according to this embodiment, the DVB SUB is converted into the Timed Text by the subtitle transcoder 50 shown in FIG. 1. In other words, the subtitle transcoder 50 generates the Text Box corresponding to, for example, rectangular areas including the regions R1 to R3 shown in FIG. 10 and sets a background color of the Text Box to be transparent, as shown in FIG. 5. The subtitle transcoder 50 sets a white space character and a line feed from an upper left part of the screen, on the Text Box, and sets the subtitle display regions R1 to R3 at display positions designated in the DVB SUB. Then, the subtitle transcoder 50 employs the highlight function as a decorating function which can be employed in the Timed Text, and executes highlight display of each of the characters in the color designated as the background color of the DVB SUB Displaying is executed in this method, similarly to the displaying in the DVB SUB. As for the subtitles based on the data in the bit map format, the displayed characters are recognized and converted into data in the text format.

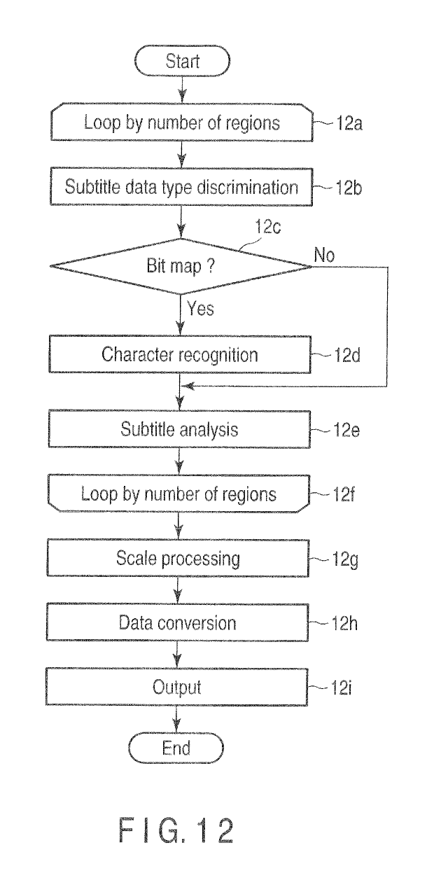

FIG. 11 shows a structure of the subtitle transcoder 50. The subtitle transcoder 50 comprises an input PES buffer 51, a parameter setting unit 52, a subtitle analyzing unit 53, a scale processing unit 34, a data conversion processing unit 55, an output buffer 56, a subtitle data discriminating unit 57 and character recognition processing unit 58. In this structure, processing shown in FIG. 12 is repeated.

The input PES buffer 51 temporarily stores the subtitle data supplied from the separation processing unit 20. In accordance with progress of the processing at a subsequent stage, the PES packet of the subtitle data to be processed is read by the subtitle analyzing unit 53.

The parameter setting unit 52 notifies the scale processing unit 51 of an output resolution, on the basis of the conversion parameter supplied from the control unit 100.

Steps 12a to 12f are loop processing. The processing in step 12b to 12e is executed for each “region” by the subtitle analyzing unit 53, the subtitle data discriminating unit 57 and the character recognition processing unit 58, to execute discrimination of the format of the subtitle sentence data, the character recognition and the subtitle analysis. In the example of FIG. 10, each of R1 to R3 is executed.

In step 12b, the subtitle data discriminating unit 57 refers to the object_id parameter of the region composition segment, for the region to be processed. The processing shifts to step 12c.

In step 12c, the subtitle data discriminating unit 57 discriminates whether the region to be processed is the subtitle sentence data in the bit map format or not, on the basis of the object ad parameter of the region composition segment. If the region to be processed is the subtitle sentence data in the bit map format, the subtitle data discriminating unit 57 outputs the data on the region to be processed, to the character recognition processing unit 58, and the processing shifts to step 12d. If the region to be processed is not the subtitle sentence data in the bit map format, the subtitle data discriminating unit 57 outputs the data on the region to be processed, to the subtitle analyzing unit 53, and the processing shifts to step 12e.

In step 12d, the character recognition processing unit 58 executes character recognition for the bit map data obtained from the object data segment of the region to be processed input through the subtitle data discriminating unit 57, detects the character string of the character sentence expressed by the bit map data, the character size, the character color and the background color, and generates the subtitle sentence data and the subtitle management data from these information elements.

In other words, the character recognition processing unit 58 converts the subtitle sentence expressed by the bit map data into the subtitle sentence data and the subtitle management data. The subtitle sentence data and the subtitle management data thus generated are output to the subtitle analyzing unit 53, and the processing shifts to step 12e. At the character recognition, the character recognition processing unit 58 may detect a corresponding font from the character shape, generate font information indicating the type of the font, and output the font information to the subtitle analyzing unit 53.

In step 12e, the subtitle analyzing unit 53 analyzes the subtitle sentence data and the subtitle management data of the region to be processed, supplied from the subtitle data discriminating unit 57 or the character recognition processing unit 58.

The subtitle analyzing unit 53 analyzes the character code and the control code in the subtitle sentence data, and detects character string in the region as a subtitle group. In addition, the subtitle analyzing unit 53 detects characters, character size, character color, background color, various decoration information included in each detected subtitle group, and detects start coordinates and end coordinates of each subtitle group. The subtitle analyzing unit 53 also analyzes the subtitle management data and changes a display format, etc. from the control code.

Step 12g is executed when the processing of steps 12b to 12e for all the regions has been completed. In step 12g, the scale processing unit 54 executes scale conversion of converting the scales such as the character size and the start and end coordinates of each group analyzed by the subtitle analyzing unit 53, on the basis of a resolution of the display of the DVB SUB and an output resolution (Text Track size) notified by the parameter setting unit 52.

For example, if the input resolution is 1920×1080 and the output resolution is 320×180, the character size and each of the coordinates are converted into one sixth. In addition, the character may not be reduced, but converted into a character of a greater size in consideration of the readability of the subtitles on a small monitor. At this time, to give priority to the display size in the horizontal direction or the vertical direction, the line feed position may be adjusted and the size of each subtitle group may be changed, or the processing as displayed in the format of a second embodiment to be described later may be executed.

If the character string length of the subtitle sentence subjected to scale conversion exceeds the end coordinates over the window, adjustment processing of enabling each subtitle group to be displayed at a desired position inside the window is executed Sir additionally executing the processing of changing the line feed and fonts and the processing of making the character size smaller.

In step 12h, the data conversion processing unit 55 first executes processing of converting 8-unit code into UTF-8 (or UTF-16) of Unicode, as the character code of the subtitle sentence in each subtitle group. Then, the data conversion processing unit 55 sets the Text Box of the size including all of the subtitle groups (subtitle groups R1 to R3 in the example of FIG. 10). The size of the Text. Box may be the same as the size of the Text Track.

Furthermore, the data conversion processing unit 55 executes processing of arranging each subtitle group inside the Text Box. In other words, the data conversion processing unit 55 refers to the start coordinates of each subtitle group which are detected by the subtitle analyzing unit 53 and which are unit 54, sets the white space character and the line feed code besides the subtitle sentence of each subtitle group such that the start coordinates are the start position of the corresponding subtitle group, adjusts the positional relationship of the image and subtitle to relatively correspond to the positional relationship of DVB SOB, and generates a Text Sample. In the example of FIG. 10, the data conversion processing unit 55 generates a Text Sample such that the positional relationship of each subtitle group is represented by the arrangement shown in FIG. 5.

In addition, the data conversion processing unit 55 executes decoration processing for the Text Sample. To execute decoration based on the decoration information (character color, scroll, blink) in the DVB SUB defected by the subtitle analyzing unit 53, for the corresponding character in the Text Sample, the data conversion processing unit 55 implements the decoration processing by applying Text Style Box, Text Scroll Delay Box, etc. to the Text Sample. Since the color designation in the DVB SUB in YCbCr format, this format is converted into RGB format.

As for the background color of each subtitle group, the data conversion processing unit 55 implements the decoration processing by applying highlight processing using Text Highlight Box and Text Highlight Color Box to the Text Sample. If the font information is generated by the character recognition of the character recognition processing unit 58, Text Sample Entry describing the sample information is generated and the corresponding font is designated by FontTableBox.

The data conversion processing unit 55 generates information on the output timing of the Text Sample, on the basis of the PTS of the PES packet. At an initial data conversion, the data conversion processing unit 55 generates Track Header Box as a header of Text Track, and Text Sample Entry in which a default parameter of Sample is set, in accordance with the Text Sample.

In step 12i, the output buffer 56 temporally stores the Text Sample generated by the data conversion of the data conversion processing unit 55 and the output timing information of the Text Sample and, at the initial data, the Text Sample Entry and the Track Header Box, in association with each other, and outputs them in accordance with the progress of the processing of the multiplexing unit 60 at the subsequent stage (or the process of the speech transcoder 30 and the image transcoder 40).

In the image processing apparatus having the above-described structure, when the DVB SUB is converted into the Timed Text, the character string in the region (converted in the character string by the character recognition, in the bit map format) is detected as a subtitle group, the start coordinates of each subtitle group are detected, the position of each subtitle group is adjusted by setting the white space character and line feed code in the Text Box, and a Text Sample including a plurality of subtitle groups is thereby generated.

Therefore, since the DVB SUB can be converted into the Timed Text without substantially changing the relative display position, the display position of the subtitles can be dynamically changed similarly to the DVB SUB, at the receiver capable of reproducing the digital broadcast in the Timed Text format. In addition, the subtitle data in the bit map format can also be converted.

### Third Embodiment

### Subtitle Data in DTVCC

Subtitle data DTVCC is a Caption Channel packet format. The subtitle data are stored in a user data area of MPEG-2 Video data of content images and reproduced synchronously with the Video data.

In DTVCC, a safe title area is provided on video display area V while leaving a margin (20% as recommended value) in each of vertical and horizontal sides, and is divided into areas called grids. The number of grids is vertically 210×horizontally 75 when an aspect ratio of image is 16:9, and vertically 160×horizontally 75 when an aspect ratio of image is 4:3.

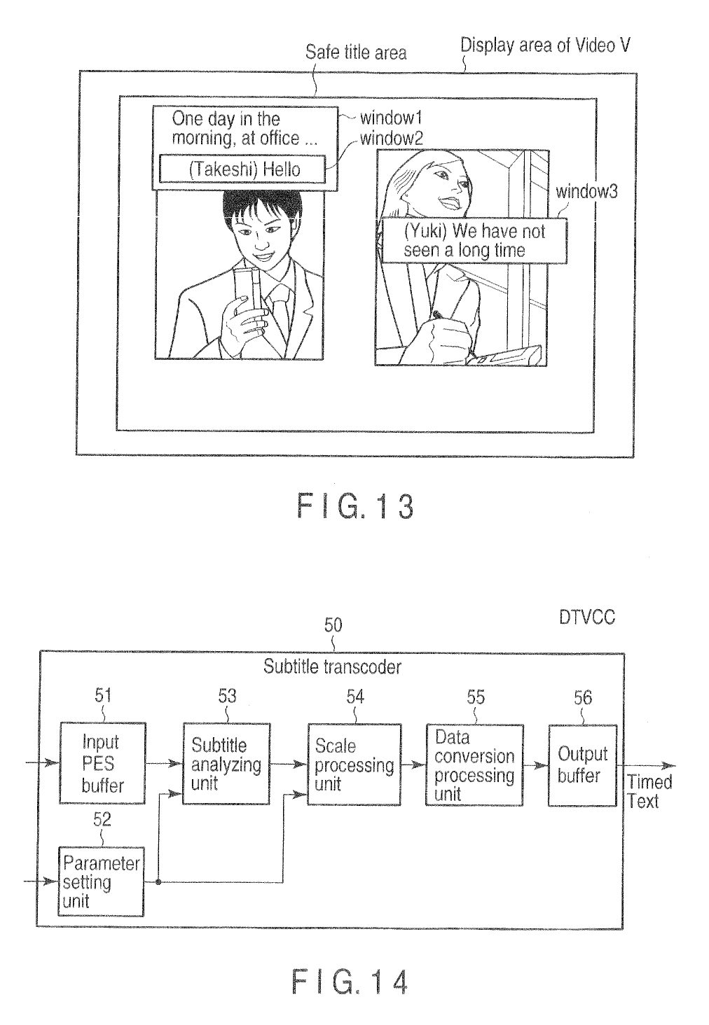

In the safe title area divided into the grids, the size is varied, the background color is set and a window is displayed as a subtitle display area, by combining arbitrarily grids. Maximum eight windows thus set can be displayed. In addition, the order of priority can be set for the windows. If the windows are superposed, the window of a higher order of priority is displayed in front. In an example of FIG. 13, the order of priority of window 2 is set to be higher than the order of priority of window 1.

By control code SWA in the subtitle data, the window can be scrolled, a display effect, a background color, etc. of the window can be set, and a plurality of windows can be arranged. As for the subtitle sentence displayed in the window, modification of size, font, underline, etc. can beset in a unit of character by SPA control code in the subtitle sentence data, and the character code, background color, etc. can be set by SPC control code in the subtitle sentence code.

On the other hand, in the Timed Text, a display area Text Box whose background color can be designated can be set at an arbitrary location in logical area Text Track, of display area D on the display, as shown in FIG. 4, and a subtitle sentence whose character color is designated in a unit of character can be displayed in the Text Box. However, since the Timed Text does not have a function of designating the display position in a unit of window and a function of designating the background color, unlike the DTVCC, or a function of setting the order of priority for the windows and superposing the windows, the DTVCC cannot be simply converted into the Timed Text.

For this reason, in the broadcast receiving apparatus according to this embodiment, the DTVCC is converted into the Timed. Text by the subtitle transcoder 50 shown in FIG. 1. In other words, the subtitle transcoder 50 generates the Text. Box corresponding to, for example, rectangular areas including respective window 1 to window 3 shown in FIG. 13 and sets a background color of the Text Box to be transparent, as shown in FIG. 5. The subtitle transcoder 50 sets a white space character and a line feed from an upper left part of the screen, on the Text Box, and sets the subtitle display areas R1 to R3 at display positions designated in the DTVCC. Then, the subtitle transcoder 50 employs the highlight function as a decorating function which can be employed in the Timed Text and executes highlight display of each of the characters in the color designated as the background color of the DTVCC. Displaying is executed in this method, similarly to the displaying in the DTVCC.

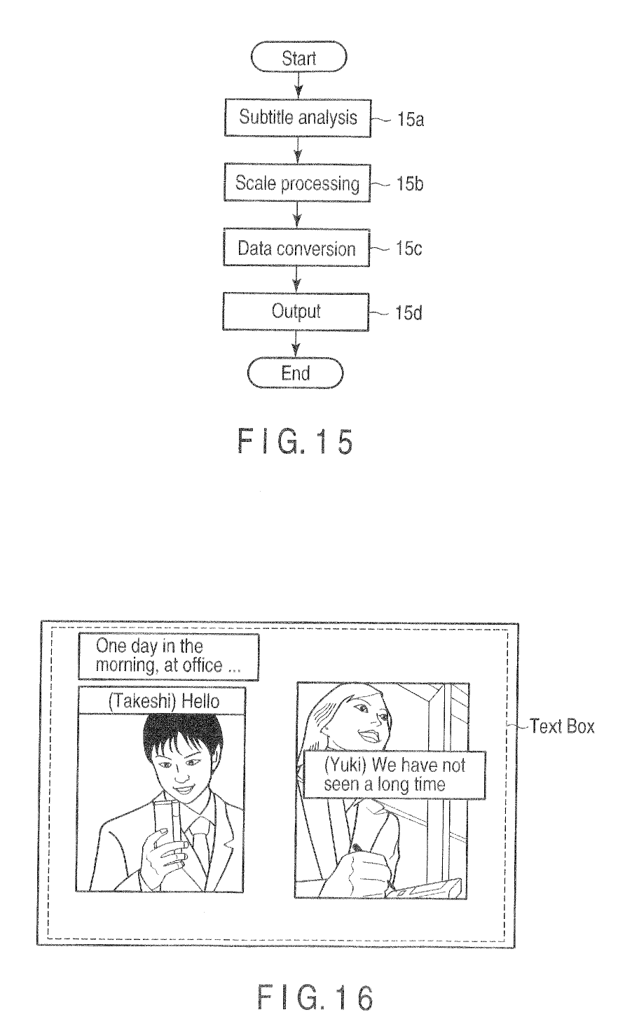

FIG. 14 shows a structure of the subtitle transcoder 50. The subtitle transcoder 50 comprises an input PES buffer 51, a parameter setting unit to, a subtitle analyzing unit 53, a scale processing unit 54, a data conversion processing unit 55, and an output buffer 56. In this structure, processing shown in FIG. 15 is repeated.

The input PES buffer 51 temporarily stores the subtitle data supplied from the separation processing unit 20. In accordance with progress of the processing at a subsequent stage, a packet of the subtitle data to be processed is read by the subtitle analyzing unit 53.

The parameter setting unit 52 notifies the scale processing unit 54 of an output resolution in which the DTVCC is converted into the Timed Text, on the basis of the conversion parameter supplied from the control unit 100.

The subtitle analyzing unit 53 analyzes the DTVCC and detects a character string in the window as a subtitle group in step 15a. In addition, the subtitle analyzing unit 53 detects characters, character size, character color, background color, various decoration information included in each detected subtitle group, and detects start coordinates and end coordinates of each subtitle group from the DTVCC.

The start coordinates and end coordinates are converted into position information of a coordinate system represented by pixel values with the upper left part of video display area V regarded as the origin, on the basis of the information indicating the positions of the grids which constitute the window. As the character size, set values of three stages called STANDARD, LARGE, SMALL designated by the SPA are converted into the pixel values. If the font is designated, the corresponding font may be selected to generate the font information.

The scale processing unit 54 executes scale conversion of converting the scales such as the character size and the start and end coordinates of each group analyzed by the subtitle analyzing unit 53, on the basis of the video display area V and an output resolution (Text Track size) notified by the parameter setting unit 52, in step 15b.

For example, if the input resolution is 1920×1080 and the output resolution is 320×180, the character size and each of the coordinates are converted into one sixth. In addition, the character may not be reduced, but converted into a character of a greater size in consideration of the readability of the subtitles on a small monitor. At this time, to give priority to the display size in the horizontal direction or the vertical direction, the line feed position may be adjusted and the size of each subtitle group may be changed, or the processing as displayed in the format of a second embodiment to be described later may be executed.

If the windows are superposed, the scale processing unit 54 varies the character size and changes the display positions of the windows to correct the superposition.

If the character string length of the subtitle sentence subjected to scale conversion exceeds the end coordinates over display area E, adjustment processing of enabling each subtitle group to be displayed at a desired position inside the display area E is executed by additionally executing the processing of changing the line feed and fonts and the processing of flaking the character size smaller.

The data conversion processing unit 55 first executes processing of converting 8-unit code into UTF-8 (or UTE-16) of Unicode, as the character code of the subtitle sentence in each subtitle group, in step 15c. Then, the data conversion processing unit 55 sets the Text Box of the size including all of the subtitle groups (window 1 to window 3 in the example of FIG. 13). The size of the Text Box may be the same as the size of the Text Track.

Furthermore, the data conversion processing unit 55 executes processing of arranging each subtitle group inside the Text Box. In other words, the data conversion processing unit 55 refers the start coordinates of each subtitle group which are detected by the subtitle analyzing unit 53 and which are subjected to scale conversion by the scale processing unit 54, sets the white space character and the line feed code besides the subtitle sentence of each subtitle group such that the start coordinates are the start position of the corresponding subtitle group, adjusts the positional relationship of the image and subtitle to relatively correspond to the positional relationship of DTVCC, and generates a Text Sample. In the example of FIG. 13, the data conversion processing unit 55 generates a Text Sample such that the relationship of each subtitle group is represented by the arrangement shown in FIG. 16.

In addition, the data conversion processing unit 55 executes decoration, processing for the Text Sample. To execute decoration based on the decoration information (character color, scroll, blink) in the DTVCC detected by the subtitle analyzing unit 53, for the corresponding character in the Text Sample, the data conversion processing unit 55 implements the decoration processing by applying Text Style Box, Text Scroll Delay Box, etc. to the Text Sample. The colors designated in the DTVCC are entirely 64 colors, 2 bits in each of RGB. However, since each of RGB is in 8 bits in the Timed Text, a 2-bit RGB value is converted into an 8-bit KGB value.

As for the background color of each subtitle group, the data conversion processing unit 55 implements the decoration processing by applying highlight processing using Text Highlight Box and Text Highlight Color Box to the Text Sample. In addition, if the scrolling is designated, the data conversion processing unit 55 sets the start and end timings of scrolling in the Text Sample Entry, and sets delay of scrolling by the Text Scroll Delay Box. If the font information is generated, the data conversion processing unit 55 generates the Text Sample Entry describing the sample information and designates the font by the Font Table Box.

The data conversion processing unit 55 generates information on the output timing of the Text Sample, on the basis of the PTS of the Video. At an initial data conversion, the data conversion processing unit 55 generates Track Header Box as a header of Text Track, and Text Sample Entry in which a default parameter of Sample is set, in accordance with the Text Sample.

The output buffer 56 temporally stores the Text Sample generated by the data conversion of the data conversion processing unit 55 and the output timing information of the Text Sample and, at the initial data, the Text Sample Entry and the Track Header Box, in association with each other, and outputs them in accordance with the progress of the processing of the multiplexing unit 60 at the subsequent stage (or the process of the speech transcoder 30 and the image transcoder 40), in step 15d.

In the image processing apparatus having the above-described structure, when the DTVCC is converted into Timed Text, the character string in the window is detected as a subtitle group, the start coordinates of each subtitle group are detected, the position of each subtitle group is adjusted by setting the white space character and lire feed code in the Text Box, and a Text Sample including a plurality of subtitle groups is thereby generated.

Therefore, since the DTVCC can be converted into the Timed Text without substantially changing the relative display position, the display position of the subtitles can be dynamically changed similarly to the DTVCC, at the receiver capable of reproducing the digital broadcast in the Timed Text format.

The present embodiment is not limited to the embodiments described above but the constituent elements of the embodiment can be modified so various manners without departing from the spirit and scope of the embodiment. Various aspects of the embodiment can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

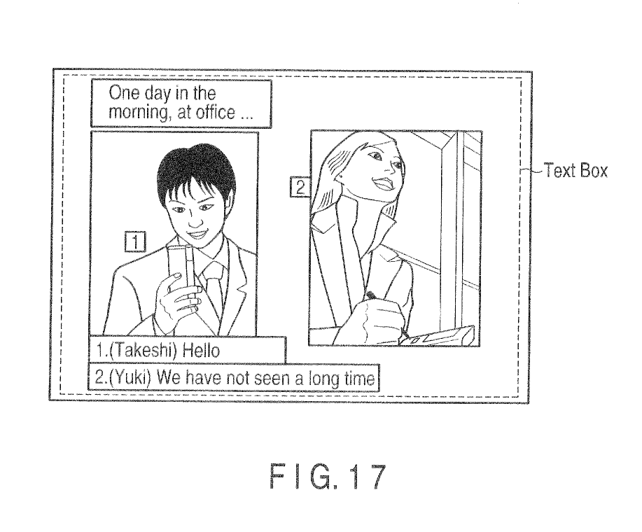

For example, the data are converted into the Timed Text as shown in FIG. 5 by the data conversion processing unit 55 in the first and second embodiments, and the data are converted into the Timed Text as shown in FIG. 17 by the data conversion processing unit SS in the third embodiment. In other words, the same subtitles are displayed at the same position as the original subtitle sentence data (ISDB-T SUB, DVB SUB or DTVCC).

Instead of this, however, the data conversion processing unit 55 may generate the Text Sample to display the index number (“1” and “2” in FIG. 17) alone at the position corresponding to the original subtitle sentence data, and may generate the Text Sample to display the index number and the subtitle sentence in association with each other at an outer peripheral portion of the Text Box (lower part in the example of FIG. 17), as shown in FIG. 17.

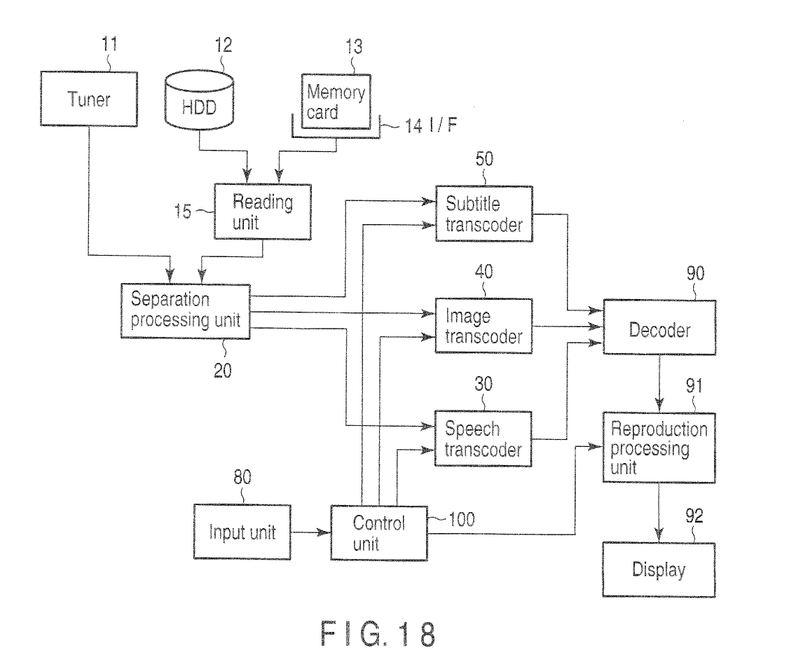

In the above-described embodiments, the digital broadcast is transcoded and then recorded in the hard disk drive 12 and the memory card 13 as shown in FIG. 1. Instead of this, for example, the transcoded multimedia data may be decoded and reproduced as shown in FIG. 18. In this case, turning on and off the subtitle reproduction can also be switched at any time by the user input of designating display and non-display of the subtitles from the input unit 80. This is implemented by stopping the processing of the subtitle transcoder 50, stopping the decoding of the subtitles by the decoder 90, and stopping the overlay of the subtitles by a reproduction processing unit 91.

In the broadcast receiving apparatus shown in FIG. 18, the decoder 90 decodes the speech data output from the speech transcoder 30, the image data output from the image transcoder 40, and the subtitle data output from the subtitle transcoder 50 to obtain the speech signal, image signal and subtitle signal. Then, the reproduction processing unit 91 urges a display 92 to display an image on which subtitles are superimposed, on the basis of the image signal and the subtitle signal. Thus, the transcoded multimedia data can also be applied to the broadcast receiving apparatus which does not execute re-recording.

In addition, in the embodiments, the Text Box corresponding to the rectangular areas including the subtitle data in each format (ISDB-T SUB, DVB SUB or DTVCC) is generated. However, the Text Box corresponding to an area corresponding to then entire display area may be generated.

Furthermore, the subtitle sentence is detected from the subtitle data in each format (ISDB-T SUB, DVB SUB or DTVCC). However, the subtitle sentence and the display position thereof may be detected by subjecting the image on which the subtitles are superimposed to the character recognition, and the subtitle data in the Timed Text format may be generated on the basis of the detection result. At a position where no character is present, a non-color white space character is set.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a receiving unit configured to receive a broadcast signal employing a first subtitle format capable of designating a display position and executing a plurality of subtitle displays;
a display position detecting unit configured to detect a display position of a subtitle in accordance with subtitle information included in the broadcast signal received by the receiving unit;
a character string detecting unit configured to detect a character string of the subtitle in accordance with the subtitle information; and
a subtitle generating unit configured to generate subtitle information in a second subtitle format in capable of executing a plurality of subtitle displays,
wherein the subtitle generating unit arranges white space characters as the subtitle from a start point of a display area of the subtitle, arranges the character string detected by the character string detecting unit, and generates the subtitle information in the second subtitle format, to display the character string detected by the character string detecting unit at the display position detected by the display position detecting unit.

2. The apparatus according to claim 1, wherein the character string detecting unit detects the character string in the subtitle by recognizing a character from image data included in the subtitle information.

3. The apparatus according to claim 1, wherein to detect a display area including an entire display position detected by the display position detecting unit and to display the character string detected by the character string detecting unit at the display position detected by the display position detecting unit, the subtitle generating unit arranges the white space characters as the subtitle from a start point of the display area, arranges the character string detected by the character string detecting unit, and generates the subtitle information in the second subtitle format.

4. The apparatus according to claim 3, wherein the character string detecting unit detects the character string of the subtitle sequential in a vertical or horizontal direction as a group; and
the display position detecting unit detects a display position of the group.

5. An image processing apparatus comprising:
a receiving unit configured to receive a broadcast signal employing a first subtitle format capable of designating a display position and executing a plurality of subtitle displays;
a display position detecting unit configured to detect a display position of a subtitle in accordance with subtitle information included in the broadcast signal received by the receiving unit;
a character string detecting unit configured to detect a character string of the subtitle in accordance with the subtitle information; and
a subtitle generating unit configured to generate subtitle information in a second subtitle format in capable of executing a plurality of subtitle displays,
wherein to display an index at the display position detected by the display position detecting unit, the subtitle generating unit arranges white space characters as the subtitle from a start point of a display area of the subtitle and arranges the index; and
to display the character string of the subtitle corresponding to the index at an end part of the display area of the subtitle, the subtitle generating unit further aligns white space characters, arranges the character string at the subtitle corresponding to the index, and generates the subtitle information in the second subtitle format.

6. The apparatus according to claim 5, wherein the character string detecting unit detects the character string in the subtitle by recognizing a character from image data included in the subtitle information.

7. The apparatus according to claim 5, wherein to detect a display area including an entire display position detected by the display position detecting unit and to display the index at the display position detected by the display position detecting unit, the subtitle generating unit arranges the white space characters as the subtitle from a start point of the display area and arranges the index; and
to display the character string of the subtitle corresponding to the index at an end part of the display area of the subtitle, the subtitle generating unit further aligns white space characters, arranges the character string of the subtitle corresponding to the index, and generates the subtitle information in the second subtitle format.

8. The apparatus according to claim 7, wherein the character string detecting unit detects the character string of the subtitle sequential in a vertical or horizontal direction as a group; and
the display position detecting unit detects a display position of the group.
